(19) United States
(12) Patent Application Publication
(10) Pub. No.: US 2012/0042592 A1
(43) Pub. Date: Feb. 23, 2012

(54) WALL ELEMENT AND METHOD FOR PRODUCING THE ELEMENT

(75) Inventor: Roger Ericsson, Sundbyberg (SE)

(73) Assignee: Givent Ltd., Msida (MT)

(21) Appl. No.: 13/138,500

(22) PCT Filed: Mar. 1, 2010
(86) PCT No.: PCT/SE2010/000045

§ 371 Date: Aug. 26, 2011

(30) Foreign Application Priority Data
Feb. 27, 2009 (SE) 0900258-5

(51) Int. Cl. E04C 2/284; B29C 39/10; E04C 2/52

(52) U.S. Cl. 52/220.1; 52/580; 264/279.1

(57) ABSTRACT

A wall element includes a substantially rectangular shape with a first and a second side substantially parallel to each other, and a third side extending between the first and second side. In at least one embodiment, the wall element includes a first continuous layer of high performance concrete; a second continuous layer of high performance concrete, the second layer is substantially parallel to the first layer; a first elongated load bearing element; a second elongated load bearing element; and a transverse load bearing beam. In at least one embodiment, the first and second load bearing element and the transverse load bearing beam are positioned between the first and the second layer to separate the first and the second layer thereby generating an intermediate space within the element between the first and second layer; the first and second load bearing element are fastened in the first and second layer and extend along the first and the second side of the element; and the transverse load bearing beam is fastened in the first and second layer and extends the third side of the element. At least one embodiment furthermore relates to a method for producing the wall element defined above.

### TECHNICAL FIELD OF THE INVENTION

The present invention relates to a wall element, a building comprising said wall element and a method for producing said wall element.

### BACKGROUND OF THE INVENTION

Concrete is a material frequently used in different types of building structures, such as for example walls separating different rooms or compartments.

Conventional prefabricated reinforced wall elements are made of concrete reinforced with iron bars and dimensioned for withstanding the loads that the element is exposed to, as well as withstanding fire and sound.

However, wall elements that is prefabricated in order to reduce the casting work that has to be done at the work place, are very heavy, which makes them difficult and thereby expensive to transport and handle. Furthermore, each wall element made of concrete requires a considerably amount of material which will have a negative effect on the price for the product.

A further drawback with the conventional prefabricated wall elements is that because of the shrinkage of the concrete, the final prefabricated elements will have a poor quality and tolerance, which in the end will require additional work to compensate for the poor quality and tolerance.

There is consequently a need for a wall element that reduces the casting work that has to be done at the constructional working place, and in the end reduce the building cost.

### SUMMARY OF THE INVENTION

The present invention, defined in independent claim 1, fulfils the needs described above. The wall element is preferably manufactured by the method according to claim 12.

The wall element has a substantially rectangular shape with a first and a second side substantially parallel to each other and a third side extending between said first and second side. The wall element comprising:
a first continuous layer of high performance concrete;
a second continuous layer of high performance concrete, said second layer is substantially parallel to the first layer;
a first elongated load bearing element;
a second elongated load bearing element; and
a transverse load bearing beam;
   wherein said first and second load bearing element and the transverse load bearing beam are positioned between the first and the second layer to separate the first and the second layer thereby generating an intermediate space within the element between the first and second layer, said first and second load bearing element are fastened in the first and second layer and extending along the first and the second side of the element, wherein said transverse load bearing beam is fastened in the first and second layer and extending along the third side of the element.

In the wall element according to the invention, the elongated load bearing elements provides the required structural strength which means that the area of the wall element between the two load bearing elements not has to be able to withstand the same loads. Furthermore the transverse load bearing beam provides strength in the transverse direction so that the shear forces on the layers are reduced.

One essential feature in the element according to the invention is the use of high performance concrete in the load bearing elements. The high performance concrete differs from conventional ordinary concrete in that it has a higher compressive strength. The compressive strength for high performance concrete is above 80 MPa. Furthermore, the water/concrete ratio for the concrete paste should be below 0,39. This ration ensure that the amount of water in sufficiently low in relation to the amount of concrete to reach the desired strength. The specified high performance concrete has several advantageous properties such as almost no shrinking during curing, no creep over time, etc.

The wall element according to the present invention has several advantages compared to conventional prefabricated walls. First, the high performance concrete do not shrink during curing which means that the final wall element could be produced within narrow tolerances which reduce the additional work that has to be done later on in the building process when different elements are put together. The reduced amount of work saves time, and consequently also the overall building cost.

Secondly, the amount of concrete and reinforcement material will be reduced thereby reducing the cost for material. Furthermore the reduced weight makes it easier to transport, handle and use the elements.

In one embodiment of the wall element according to the invention, said first and second layer have a thickness of at least 13 mm. This thickness provides sufficient layer strength in order to make it possible to produce and handle the elements without breaking the layers.

In one embodiment of the wall element, said first and second layer have different thicknesses. This embodiment is very favourable if an efficient damping of sound is required since the different thicknesses of the layers will affect different wave-lengths thereby providing an efficient damping.

In one embodiment of the wall element, said intermediate space within the element have a substantially constant width, said width being at least 20 mm.

In one embodiment of the wall element, said load bearing elements extend along the entire first and second side of the wall element.

In one embodiment of the wall element, the first and/or the second load bearing element comprises reinforcement bars. The reinforcement bars provides load bearing elements with sufficient strength to withstand high loads.

In one embodiment of the wall element, at least one layer of insulating material is arranged between the first and the second layer. This embodiment makes it possible to adapt the wall element for different purposes such as providing a wall element with the desired thermal insulation properties and/or sound insulation properties.

In one embodiment of the wall element, pipes for ventilation, wires, cables or other components are arranged between the first and the second layer. This is a very favourable embodiment of the wall element since essential components that are required in the final building where the element is used could be arranged in the wall element between the first and second layer.

The invention furthermore relates to a building structure comprising at least one wall element according to anyone of the embodiments described above.

In said building the first and second load bearing elements extend in substantially vertical direction to be able to bear the vertical loads in the building.

The invention furthermore relates to a method for producing a wall element according to anyone of the embodiments above. The method comprising the steps:
a) cast the first continuous layer in a substantially horizontal mould;
b) positioning a casting mould on the top surface of the first layer;
c) arranging reinforcement bars for the longitudinal load bearing elements within recesses in the casting mould;
d) introduce high performance concrete into the recesses in the mould to cast the supporting elements;
e) cover the mould by high performance concrete to cast the second continuous layer;
f) cure the high performance concrete; and remove the casting mould.

This method makes it possible to prefabricate wall elements in a very efficient way since the first and second layers and the load bearing elements are formed during one single process within the mould before the high performance concrete forming the first and second layer as well as the load bearing elements finally is cured. The overall production time is thereby reduced considerably and since the high performance concrete do not shrink, the wall element after the curing is completed and the casting mould removed will have the intended dimensions and be ready for use.

In one embodiment of the method according to the invention, said method further comprises a step where reinforcement bars are introduced in the first layer before step b) is initiated in order to provide a first layer with the desired strength.

In one embodiment of the method according to the invention, said method further comprises a step where reinforcement bars are introduced in the second layer before the curing of the high performance concrete is initiated in order to provide a second layer with the desired strength.

In one embodiment of the method according to the invention, said method further comprises the step of arranging at least one layer of insulation on the casting mould before the high performance concrete is introduced in the mould.

Different embodiments of the wall element and the method for producing said element could of course be combined without departing from the scope of the invention. Further advantages and details of the invention will be recognised in the detailed description.

### BRIEF DESCRIPTION OF THE DRAWINGS

Different embodiments of the present invention are illustrated in the appended drawings, in which:

FIG. 1 illustrates a front view of a wall element.

FIG. 2 illustrates a vertical cross sectional view of the wall element in FIG. 1.

FIG. 3 illustrates a horizontal view of the wall element in FIG. 1.

FIG. 4 illustrates a horizontal view of a second embodiment of a wall element.

FIG. 5 illustrates a horizontal view of a third embodiment of a wall element.

FIG. 6 illustrates a horizontal view of a fourth embodiment of a wall element.

FIG. 7 illustrates a front view of a second embodiment of a wall element.

FIG. 8 illustrates a vertical cross sectional view of the wall element in FIG. 7.

FIG. 9 illustrates a horizontal view of the wall element in FIG. 7.

FIG. 10 illustrates a horizontal view of the wall element in FIG. 7.

FIG. 11 illustrates a cross sectional view of a wall element supporting a floor structure.

FIG. 12-14 illustrates schematically the method for production of a wall element.

### DETAILED DESCRIPTION

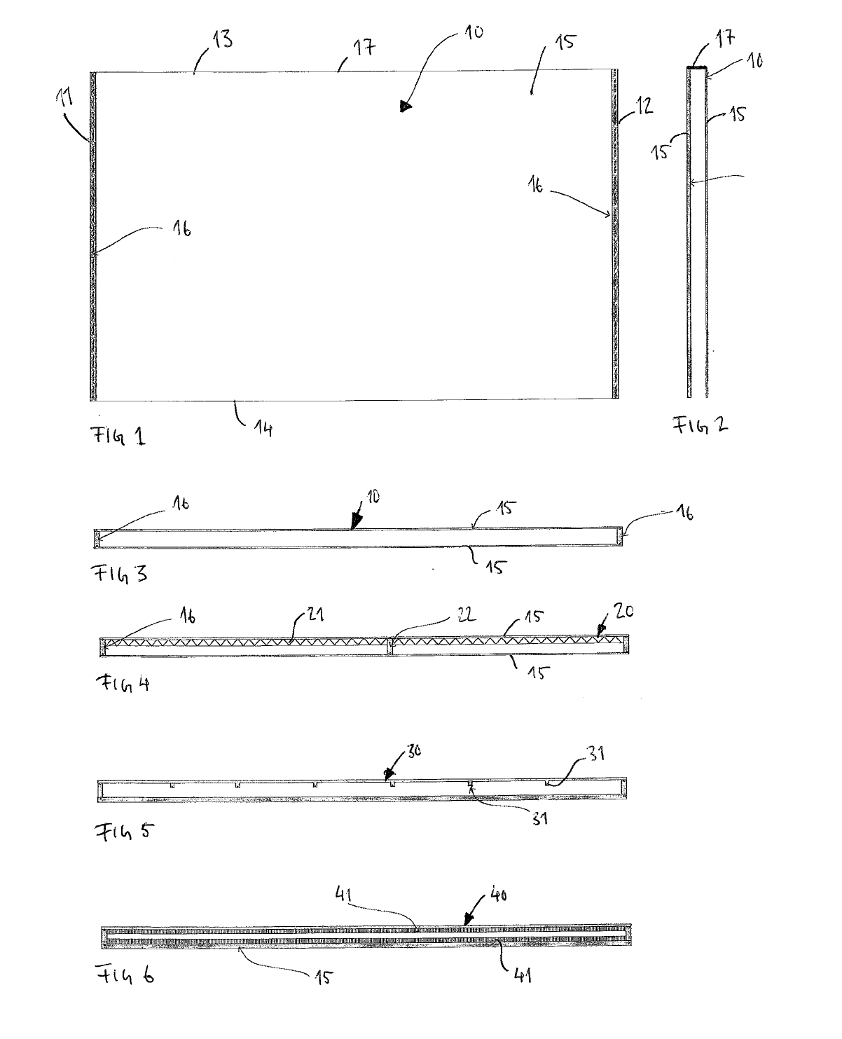

In FIGS. 1, 2 and 3, a first wall element according 10 to the present invention is illustrated. The wall element has a substantially rectangular shape with a first 11, a second 12, a third 13 and a fourth side 14. The first and second side is substantially parallel and extending in vertical direction while the third and fourth side is substantially parallel and horizontal.

The wall element comprises two substantially flat continuous layers 15 bounded together by a first and a second longitudinal load bearing element 16 arranged along the first and second side of the element 10 so that a wall element with substantially parallel layers is generated.

The load bearing elements have a substantially rectangular cross section and dimensioned to withstand the expected vertical loads on the wall element which means that the cross sectional area and the reinforcement of the load bearing elements could vary.

Along the third side, the two layers are bounded together by a transverse load bearing beam 17. This beam is intended for stabilization of the two layers and increasing the strength of the wall element against shear forces that might occur in a building structure.

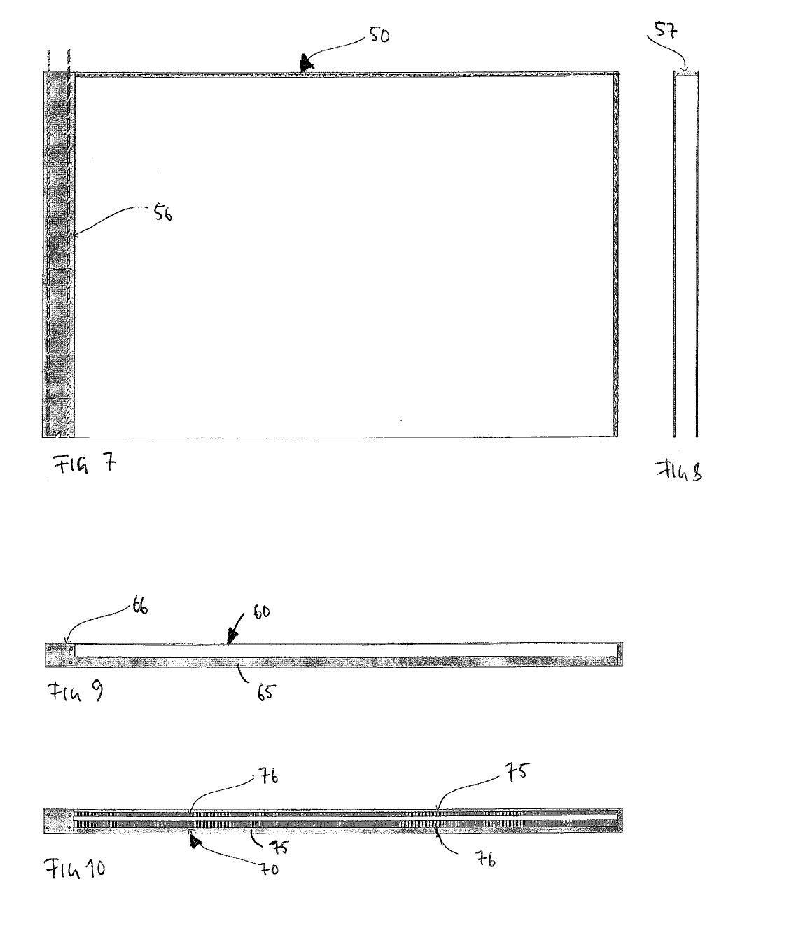

In FIG. 4, a second embodiment of a wall element 20 is illustrated. In this embodiment the inside surface of one of the layers is provided with an insulating layer 21 in order to improve the thermal insulation and sound insulation of the element. Furthermore, a vertical stiffening wall 22 is arranged between the layers in order to prevent buckling of the layers when exposed to loads and increase the overall stiffness of the layers which could be beneficial to avoid damages of the wall element during transportation and mounting of the elements.

In FIG. 5, a third embodiment of a wall element 30 is illustrated. In this embodiment the inside surface of one of the layers is provided with protrusions 31 extending parallel to the load bearing elements. These protrusions are also used for increasing the stiffness of layer and prevent buckling and damage of a thin layer.

In FIG. 6, a fourth embodiment of a wall element 40 is illustrated. In this embodiment the two layers have different thicknesses which increase the sound insulation of the wall element considerably. To improve the insulation further, the inside surface of both layers are covered by an insulating layer 41.

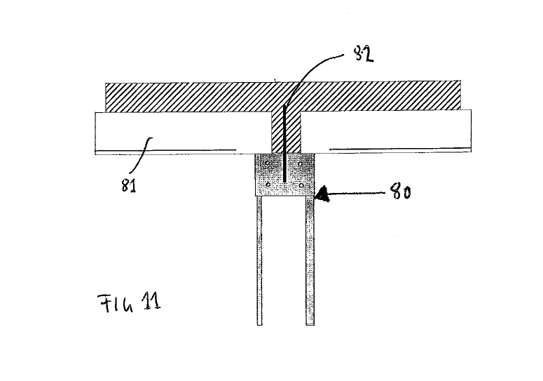

In FIGS. 7 and 8, a fifth embodiment of a wall element 50 is illustrated. This embodiment of the wall element is dimensioned to be able to bear considerably larger loads. One of the vertical load bearing elements is in this embodiment shaped as a reinforced load bearing column and the transverse load bearing beam is stronger.

In FIG. 9, a sixth embodiment of a wall element 60 is illustrated. In this embodiment one of the layers 65 have a considerably larger thickness which further increases the structural strength of the wall element.

In FIG. 10, a seventh embodiment of a wall element 70 is illustrated. In this embodiment the two layers 75 have different thicknesses which increase the sound insulation of the wall element considerably. To improve the insulation further, the inside surface of each layer are covered by an insulating layer 76.

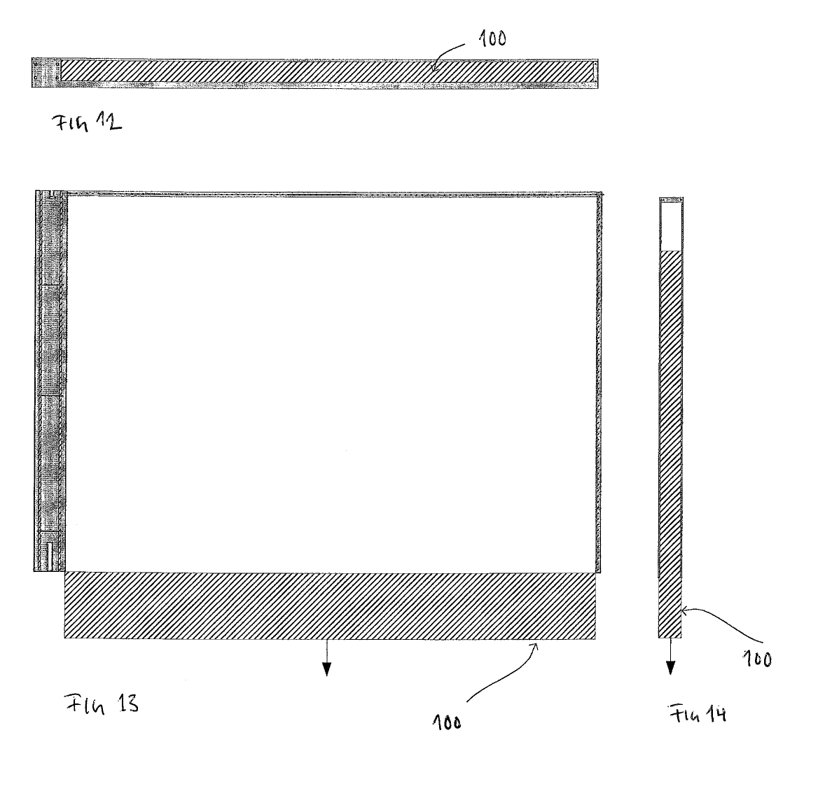

FIG. 11 discloses a wall element 80 arranged to support a floor structure 81 within a building. The wall element is along the transverse load bearing beam provided with a protrusion 82 to support the wall element in relation to the floor structure.

FIG. 12-14 illustrates schematically the method for production of a wall element according to the invention. The method is defined in the appended method claims and comprises the steps:
a) cast the first continuous layer in a substantially horizontal mould;
b) positioning a casting mould 100 on the top surface of the first layer;
c) arranging reinforcement bars for the longitudinal load bearing elements and the transverse load bearing beam within recesses in the casting mould;
d) introduce high performance concrete into the recesses in the mould to cast the load bearing elements and the load bearing beam;
e) cover the mould by high performance concrete to cast the second continuous layer;
f) cure the high performance concrete; and remove the casting mould.

Step a) is performed by pouring high performance concrete into a mould with the desired dimension, not illustrated. As soon as the first continuous layer is settled in the mould, a casting mould 100 is arranged on the top surface of the first layer.

It should be noted that step c) also cold be performed before step a) without changing the final product.

After the concrete is cured, the mould 100 is drawn out of the wall element via the open fourth side 14 of the element.

While some presently preferred embodiment of the invention has been described herein, it is to be understood that these embodiments could be combined in any suitably way without departing from the scope of the invention. The invention is not limited to the disclosed embodiments but covers and includes any and all modifications and variations that are encompassed by the following claims.

1. Wall element including a substantially rectangular shape with a first and a second side substantially parallel to each other, and including a third side extending between said first and second side, said wall element comprising:
a first continuous layer of high performance concrete;
a second continuous layer of high performance concrete, said second layer being substantially parallel to the first layer;
a first elongated load bearing element;
a second elongated load bearing element; and
a transverse load bearing beam;
wherein said first and second load bearing element and the transverse load bearing beam are positioned between the first and the second layer to separate the first and the second layer, thereby generating an intermediate space within the element between the first and second layer, wherein said first and second load bearing element are fastened in the first and second layer and extend along the first and the second side of the element, and wherein said transverse load bearing beam is fastened in the first and second layer and extends along the third side of the element.

2. Wall element according to claim 1, wherein said first and second layer include a thickness of at least 13 mm.

3. Wall element according to claim 1, wherein said first and second layer include different thicknesses.

4. Wall element according to claim 1, wherein said intermediate space within the element includes a substantially constant width, said width being at least 20 mm.

5. Wall element according to claims 1, wherein said load bearing elements extend along the entire first and second side of the wall element.

6. Wall element according to claim 1, wherein at least one of the first and the second supporting element comprises reinforcement bars.

7. Wall element according to claim 1, wherein at least one layer of insulating material is arranged between the first and the second layer.

8. Wall element according to claim 1, wherein pipes for ventilation, wires, cables or other components are arranged between the first and the second layer.

9. Building structure comprising at least one wall element according to claim 1.

10. Building structure according to claim 10, wherein the first and second load bearing elements extend in substantially vertical direction.

11. Method for producing a wall element, said method comprising:
casting a first continuous layer in a substantially horizontal mould;
positioning a casting mould on a top surface of the first layer;
arranging reinforcement bars for longitudinal load bearing elements and a transverse load bearing beam within recesses in the casting mould;
introducing high performance concrete into the recesses in the mould to cast the load bearing elements and the load bearing beam;
covering the mould by high performance concrete to cast a second continuous layer;
curing the high performance concrete; and
removing the casting mould.

12. Method according to claim 11, further comprising:
introducing reinforcement bars in the first layer before the positioning is initiated.

13. Method according to claim 11, further comprising:
introducing reinforcement in the second layer before the curing of the high performance concrete is initiated.

14. Method according to claim 11, further comprising:
arranging at least one layer of insulation on the casting mould before the high performance concrete is introduced in the mould.
